(19) United States
(12) Patent Application Publication
(10) Pub. No.: US 2013/0293559 A1
(43) Pub. Date: Nov. 7, 2013

(54) METHOD FOR SETTING PANEL PARAMETER AND ASSOCIATED CONTROLLER

(71) Applicant: Tai-Yu Liu, Hsinchu County (TW)

(72) Inventor: Tai-Yu Liu, Hsinchu County (TW)

(73) Assignee: MStar Semiconductor, Inc., Hsinchu County (TW)

(21) Appl. No.: 13/591,333

(22) Filed: Aug. 22, 2012

(30) Foreign Application Priority Data
May 3, 2012 (TW) 101115805

(51) Int. Cl. G06T 1/60

(52) U.S. Cl. 345/530

(57) ABSTRACT

A method for automatically setting a panel parameter of a display device is provided. The display device includes a controller and a display panel. The method includes steps of: storing a plurality of panel parameters respectively corresponding to different types of panels to a non-volatile memory; detecting a status signal of a predetermined pin, the status signal corresponding to the type of the display panel; selecting one panel parameter from the panel parameters according to the status signal; and generating an output signal according to the selected panel parameter by the controller.

This application claims the benefit of Taiwan application Serial No. 101115805, filed May 3, 2012, the subject matter of which is incorporated herein by reference.

### BACKGROUND OF THE INVENTION

1. Field of the Invention

The invention relates in general to a method for setting a panel parameter, and more particularly, to a method for automatically setting a panel parameter according to a status signal of predetermined pins of a controller.

2. Description of the Related Art

A panel controller is usually designed in a way that it is applicable to panels of different model numbers. For examples, operations of television panels of a same series, but having different model numbers, can be controlled by a same controller, with the model numbers representing various types of the television panels.

To provide the panels in different model numbers with optimal display effects, the controller is built-in with different panel parameters, which are also referred to as video output setting values. These panel parameters may include setting values such as a panel resolution, a horizontal total pixel count (Hₜₒₜₐₗ), a vertical total pixel count (Vₜₒₜₐₗ), a display interval, and a display frequency. In other words, to apply a same controller to panels in different model numbers, a corresponding panel parameter of a panel in a desired model number is to be first provided so that the controller is enabled to accordingly provide appropriate display signals.

It is common knowledge that an integrated circuit design house cannot predict the model numbers of panels to which the controller is to be applied. Therefore, an integrated circuit design house can only provide panel parameters corresponding to different model numbers to panel assembly houses.

After affixing the controller to a printed circuit board and before the assembling process, the controller learns corresponding panel parameters through a manual approach. FIG. 1 shows a conventional method of manually setting panel parameters. Assume that a panel A, a panel B, and a panel C, having three different model numbers are on a production line. In Step S102, assembly staff first confirms whether the panel type to which the controller is to be applied is the panel A type, the panel B type, or the panel C type.

In Step S112, when it is confirmed that the controller is to be applied to the panel A, the assembly staff loads the panel parameter of the panel A to a non-volatile memory (e.g., a flash memory, or an electrically-erasable programmable read-only memory (EEPROM)) in the controller. In Step S114, the assembly staff sets the controller such that the controller operates according to the panel parameter of the panel A. In Step S116, the controller generates an output signal according to the panel parameter of the panel A.

Similarly, in Step S122, when it is confirmed that the controller is to be applied to the panel B, the assembly staff loads the panel parameter of the panel B to the non-volatile memory in the controller. In Step S124, the assembly staff sets the controller such that the controller operates according to the panel parameter of the panel B. In Step S126, the controller generates an output signal according to the panel parameter of the panel B.

Similarly, in Step S132, when it is confirmed that the controller is to be applied to the panel C, the assembly staff loads the panel parameter of the panel C to the non-volatile memory in the controller. In Step S134, the assembly staff sets the controller such that the controller operates according to the panel parameter of the panel C. In Step S136, the controller generates an output signal according to the panel parameter of the panel C.

It is quite apparent from the above descriptions that, a conventional technique is only capable of providing different panel parameters with respect to panel in different model numbers by a manual approach. More specifically, after confirming the model number of the desired panel, the assembly staff manually loads the corresponding panel parameter to the non-volatile memory in the controller, and sets the controller to operate according to the corresponding panel parameter. In other words, it can be seen from FIG. 1 that, for the panels in the three model numbers A, B, and C, loading and setting procedures need to be individually performed in order to display optimized effects of the panels.

In an event that mismatching panel parameters are set to an unintended panel model number, the panel may render poor display effects or even a display failure. Moreover, when multiple panels in different model numbers need to be set, regardless of concurrently or at different time frames, multiple sets of panel parameters must be first provided, thus complicating overall management. In addition, during the production process, as previously stated, the panel parameters corresponding different panels are sequentially set in a manual manner, which further challenges the overall management.

Therefore, the conventional solution of setting panel parameters is encountered with the shortcomings of being time and effort consuming, prone to errors, complicated in management, and costly, among others.

### SUMMARY OF THE INVENTION

The invention is directed to a parameter setting method for automatically a setting panel parameter by detecting a status signal of a predetermined pin of a controller.

The disclosure provides a method for setting parameters for a display device. The display device comprises a controller and a display panel. The method comprises steps of: storing a plurality of panel parameters to a non-volatile memory, wherein the panel parameters respectively correspond to different types of panels; determining a pin from a plurality of pins of the controller; detecting a status signal of the determined pin, the status signal corresponding to the type of the display panel; selecting a panel parameter from the panel parameters according to the status signal; and generating an output signal according to the selected panel parameter by the controller.

The disclosure further provides a controller for a display device. The display device comprises a display panel and a non-volatile memory. The non-volatile memory stores a plurality of panel parameters. The controller comprises: a pin; a peripheral control unit, for detecting a status signal corresponding to a type of the display panel; a control unit, for selecting a panel parameter from the panel parameters according to the status signal; and a display control unit, for generating an output signal according to the selected panel parameter.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a conventional method of manually setting a panel parameter for an arbitrary panel type.

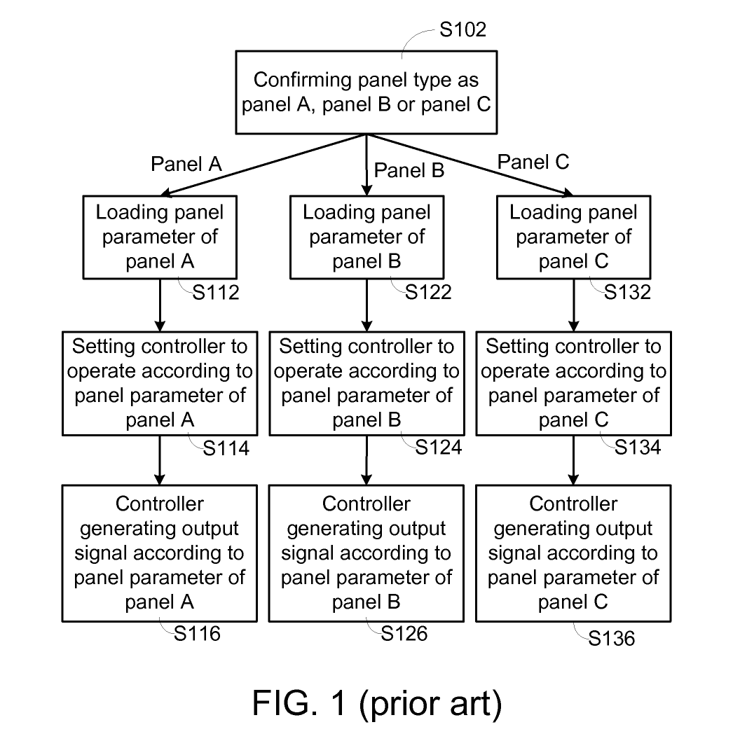

FIG. 2 is a block diagram of a controller for a display device and associated circuits according to an embodiment of the present disclosure.

FIG. 3 is a method for setting a panel parameter according to an embodiment of the present disclosure.

FIG. 4 is a block diagram of a controller for a display device and associated circuits according to another embodiment of the present disclosure.

FIG. 5 is a method for setting a panel parameter according to another embodiment of the present disclosure.

### DETAILED DESCRIPTION OF THE INVENTION

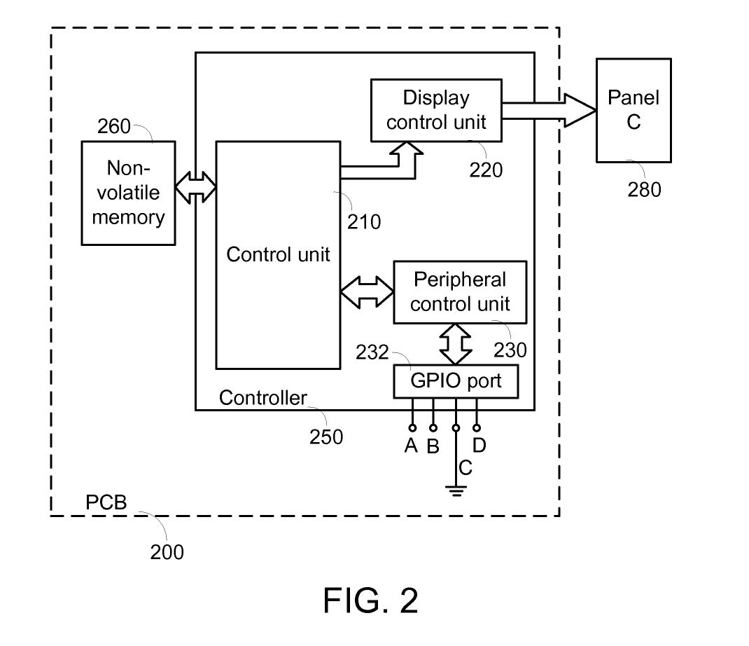

FIG. 2 shows a block diagram of a controller for a display device and associated circuits according to one embodiment of the present disclosure. A printed circuit board 200 includes a non-volatile memory 260 and a controller 250. The non-volatile memory 260 stores panel parameters of different types of panels supported by the controller 250. Each of the panel parameters includes at least one of the setting values of: a panel resolution, a horizontal total pixel count, a vertical total pixel count, a display interval, and a display frequency. In the event that a mismatched panel parameter is adopted by a controller, the panel may render poor display effects or even a display failure. The controller 250 includes a control unit 210, a peripheral control unit 230, a general purpose input/output (GPIO) port 232, and a display control unit 220. The control unit 210 controls the peripheral control unit 230 to detect a signal at the GPIO port 232, accesses content in the non-volatile memory 260, and controls and prompts the display control unit 220 to generate an output signal according to the panel parameter.

According to an embodiment of the disclosure, the type of panel to which the circuit board 200 is to be applied is first confirmed when welding the controller 250 to the printed circuit board 200. In this embodiment, the printed circuit board 200 is to be applied to a panel C 280. A plurality of predetermined pins (A, B, C, and D) of the controller 250 are welded to different signal sources to form a status signal, which corresponds to the panel C 280. Referring to FIG. 2, the predetermined pins (A, B, C, and D) are respectively formed by four pins of the GPIO port 232 of the controller 250. In the above step of welding the predetermined pins (A, B, C, and D) to different signal sources, the signal sources include high-level power signals or low-level ground signals. It should be noted that a specific pin of the predetermined pins (A, B, C, and D) can be kept floating depending on actual requirements. In this embodiment, the status signal corresponding to the panel C 280 is formed by keeping the pins A, B, and D floating and connecting the pin C to ground. Further, the pins utilized for detecting the panel type in the disclosure are not limited to the pins of the GPIO port, and other pins with similar functions may also be adopted for the detection. The GPIO port is advantaged by being low power consuming, small in package size, and programmable for adapting to versatile operations, and is thus particularly suitable for the disclosure. Moreover, the above status signal is an example for explaining the disclosure. It is known to a person skilled in the art that, 16 different status signals can be generated by four pins, meaning that 16 types of panels can be supported.

In a power-on procedure, from the pins of the controller 250, the control unit 210 designates the pins (A, B, C, and D) as predetermined pins to be detected for respectively signals, and controls the peripheral control unit 230 to detect operations of the pins (A, B, C, and D). According to a detection result of the peripheral control unit 230, the control unit 210 determines that the corresponding panel is the panel C 280. Thus, the control unit 210 selects the panel parameter corresponding to the panel C 280 from the non-volatile memory 260, and controls the display control unit 220 to generate an output signal of the controller according to the panel parameter corresponding to the panel C 280. That is to say, through detecting the status signal of the predetermined pins, the controller 250 is allowed to automatically complete setting the panel parameter. The peripheral control unit 230, as controlled by the control unit 210, performs the detection and reports the detection result. In this embodiment, the peripheral control unit 230 is controlled by the control unit 210 to detect the status signal of the predetermined pins (A, B, C, and D), and reports the detection result to the control unit 210.

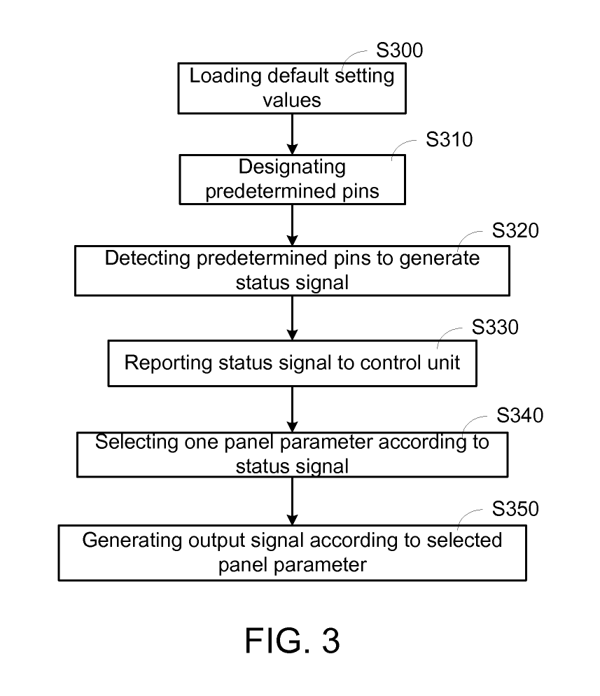

To cooperate with the operations of the foregoing controller and non-volatile memory, a method for setting a panel parameter is further provided by the disclosure. FIG. 3 shows a flowchart of a method for setting panel parameters according to one embodiment of the disclosure. In this embodiment, assume that panels including a panel A, a panel B, a panel C, and a panel D in four model numbers are on the production line. In this embodiment, the panel parameters corresponding to the panel A, the panel B, the panel C, and the panel D are pre-stored to the non-volatile memory 260. When welding the controller 250 to the printed circuit board 200, the predetermined pins of the controller 250 are respectively welded to different signal sources or are kept floating according to the panel type of the panel to be applied. In this embodiment, the panel to be applied to is the panel C 280, and so the pins A, B and D are kept floating while the pin C is connected to ground to form the status signal corresponding to the panel C 280.

Referring to FIG. 3, in Step S300, in a power-on procedure of the display device, the control unit 210 first executes a firmware code of the display device and loads default setting values stored in the non-volatile memory 260. The default setting values for various settings of the controller 250 are defined in advance by designers or operators, e.g., which pins of the controller 250 to be detected after powering on, and the panel parameters corresponding to different status signals. In Step S310, according to the default setting values, the control unit 210 designates the pins (A, B, C, and D) as the predetermined pins to be detected from the plurality of pins of the controller 250, and controls the peripheral control unit 230 to perform the detection. In Step S320, according to the command of the control unit 210, the peripheral control unit 230 respectively detects the signal sources connected to the pins (A, B, C, and D) at the GPIO port 232 to generate a status signal. In Step S330, the peripheral control unit 230 reports the detected status signal to the control unit 210. It is known with reference to FIG. 2 that, in this embodiment, the detected signal status represents that the pins A, B, and D are kept floating and the pin C is grounded. In Step S340, after receiving the foregoing status signal, the control unit 210 determines that the status signal corresponds to the panel C 280 according to information stored in the non-volatile memory 260, and selects the panel parameter corresponding to the panel C 280 from the non-volatile memory 260. That is to say, after receiving the status signal, the control unit 210 determines that the panel type to which the display device is to be applied is the panel C 280 by looking up the information stored in the non-volatile memory 260, and selects the panel parameter corresponding to the panel C 280. In Step S350, the control unit 210 controls the display control unit 220 to generate an output signal according to the panel parameter corresponding to the panel C 280 in the non-volatile memory 260. The panel parameter of the panel C 280 includes setting values corresponding to the resolution, horizontal total pixel count, vertical total pixel count, display interval, and display frequency of the panel C 280. According to the panel parameter of the panel C 280, the display control unit 220 is capable of generating an output signal suitable for the panel C 280 to allow the panel C 280 to correctly perform display.

Through the above process, the controller 250 confirms that the panel to be applied is the panel C, and automatically completes setting the panel parameter corresponding to the panel C. It should be noted that, the content that the control unit 210 reads from the non-volatile memory 260 is not limited to the panel parameter corresponding to the panel C, and may also include other pre-stored setting values.

It is known from the above descriptions that, in the method for setting a panel parameter according to the embodiment of the disclosure, by storing the panel parameters corresponding to different panel types in the non-volatile memory 260 and welding the predetermined pins to corresponding to signal sources according to the panel types to be applied to during the assembly process, settings for multiple panel parameters corresponding to different panel types can be automatically completed. In other words, in the power-on procedure, by identifying the panel type through the status signal on the pins, the corresponding panel parameter may be selected for automatic setting. Thus, the method for setting a panel parameter according to the embodiment of the disclosure eliminates the conventional manual setting procedure, and is further advantaged by being time, effort and cost effective as well as being reliable and manageable.

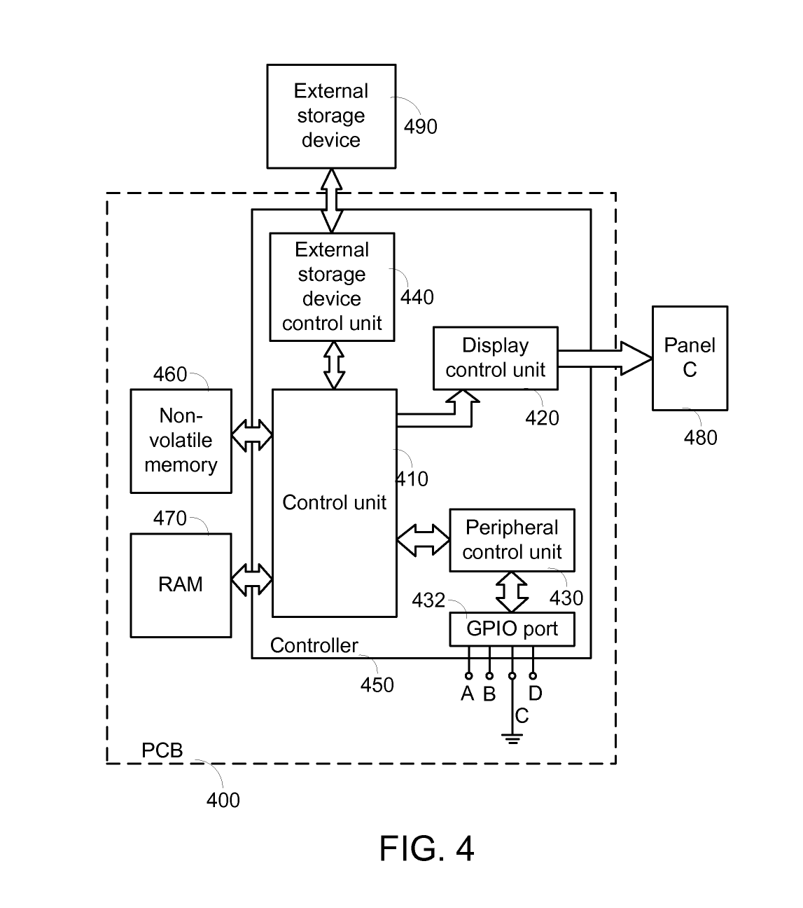

FIG. 4 shows a block diagram of a controller for a display device and associated circuits according to another embodiment of the present disclosure. With reference to the block diagram in FIG. 4 according to this embodiment, details of implementing the disclosure to a firmware update of the display device to allow a user to learn about the progress of an update through an image displayed by the display device during an update process by shall be described. A printed circuit board 400 includes a non-volatile memory 460, a random access memory (RAM) 470, and a controller 450. The controller 450 includes a control unit 410, a display control unit 420, a peripheral control unit 430, a GPIO port 432, and an external storage device control unit 440. The non-volatile memory 460, the control unit 410, the display control unit 420, the peripheral control unit 430, and the GPIO port 432 have similar functions as the non-volatile memory 260, the control unit 210, the display control unit 220, the peripheral control unit 230, and the GPIO port 232 previously described and shown in FIG. 2, and details thereof shall be omitted herein for the sake of brevity. In addition to storing the panel parameters corresponding to different types of panels, the non-volatile memory 460 further stores a firmware code of the controller 450. The RAM 470 temporarily stores a code executed by the controller 450 or generated variables during operations of the controller 450. The external storage device control unit 440 is an access unit, which is controlled by the control unit 410 to access an external storage device 490. The external storage device 490 stores a firmware update code of the controller 450, and is connected to the controller 450 via a transmission interface. In practice, the transmission interface may be a Universal Serial Bus (USB) interface or an IEEE 1394 (firewire) interface. The USB interface, featuring easy portability, standardized specifications, a hot-swappable capability and a fast transmission speed, is particularly suitable for cooperating with the disclosure for firmware updating.

During a firmware update procedure, the control unit 410 first designates the pins (A, B, C, and D) as the predetermined pins to be detected for respectively signals from the plurality of pins of the controller 450, and controls the peripheral control unit 430 to perform the detection. According to the detection result (i.e., the pins A, B, and D are kept floating, and the pin C is grounded) of the peripheral control unit 430, the control unit 410 determines that the corresponding panel is a panel C 480, and controls the controller 450 to generate an output signal according to the panel parameter according to the panel C 480. That is to say, by detecting the status signal of the predetermined pins, the controller 450 is allowed to automatically complete setting the panel parameter, so that the subsequently firmware update procedure may be displayed by the preferred panel C 480. Next, the control unit 410 stores the firmware code being executed from the non-volatile memory 460 to the RAM, and deletes the firmware code in the non-volatile memory 460. The control unit 410 then controls and prompts the external storage device control unit 440 to read a firmware update code stored in the external storage device 490, and stores the firmware update code to the non-volatile memory 460 to complete the firmware update procedure.

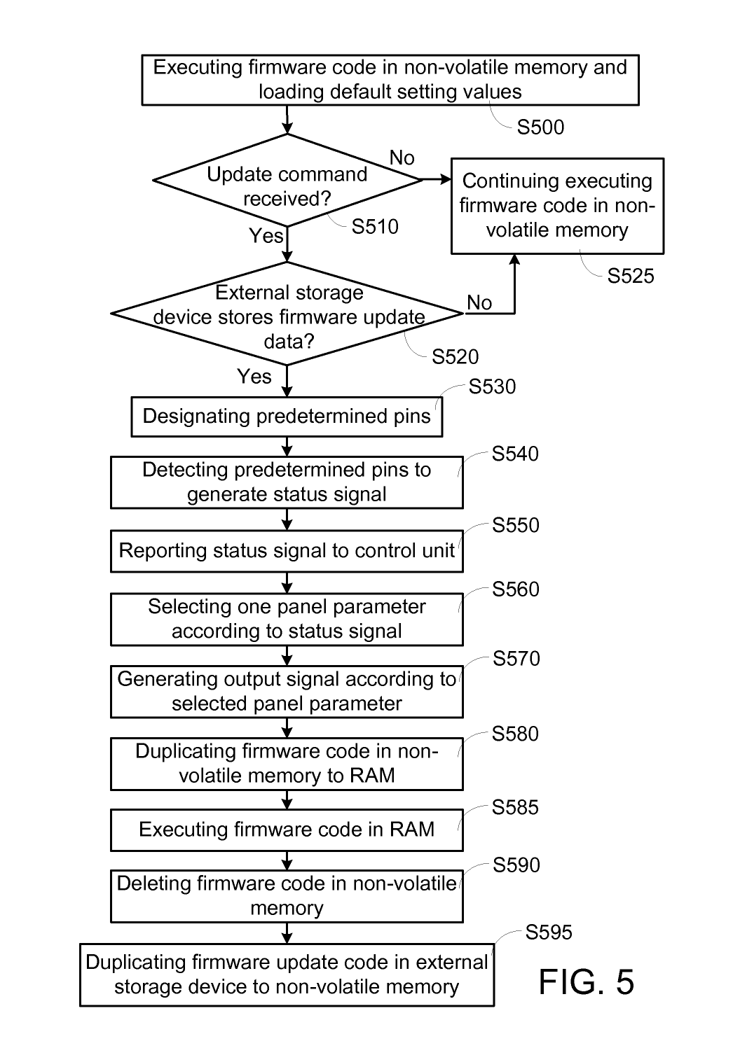

To cooperate with the operations of the foregoing controller, non-volatile memory, and RAM, a method for setting a panel parameter applied for firmware updating is further provided by the disclosure. FIG. 5 shows a flowchart of a method for setting a panel parameter according to another embodiment of the disclosure. In this embodiment, assume that panels including a panel A, a panel B, a panel C, and a panel D in four model numbers are on the production line. It should be noted that the disclosure is applicable to a situation of more than four panels. In this embodiment, the panel parameters corresponding to the panel A, the panel B, the panel C, and the panel D are pre-stored to the non-volatile memory 460. When welding the controller 450 to a printed circuit board 400, the predetermined pins of the controller 450 are respectively welded to different signal sources or are kept floating according to the panel type of the panel to be applied. In this embodiment, the panel to be applied is the panel C 480, and so the pins A, B, and D are kept floating while the pin C is grounded to form the status signal corresponding to the panel C 480.

Referring to FIG. 5, in Step S500, in a power-on procedure of the display device, the control unit 410 first executes a firmware code of the display device and loads default setting values stored in the non-volatile memory 460. The default setting values for various settings of the controller 250 are defined in advance by designers or operators, e.g., which pins of the controller 450 to be detected after powering on, and the panel parameters corresponding to different status signals. In Step S510, the control unit 410 detects whether an update command is received. The update command is typically user-initiated. For example, a user may press a power button of the display device for more than 5 seconds after power-on to inform the control unit 410 that a firmware update is desired. Other approaches for generating the update command may also be utilized. No update is required if the control unit 410 does not received any update command, and Step S525 is performed to continue executing the firmware code in the non-volatile memory 460. In contrast, in Step S520, when the control unit 410 receives the update command, the control unit 410 controls and prompts the external storage device control unit 440 to read the external storage device 490 to confirm whether the external storage device 490 contains a firmware update code. When it is confirmed that the external storage device 490 does not contain a firmware update code, or when it is confirmed that no external storage device 490 is connected to the display device, it means no update is required, and so Step S525 is performed to continue executing the firmware code in the non-volatile memory 460. In contrast, in Step S530, when it is confirmed that the external storage device 490 contains a firmware update code, the pins A, B, C, and D are designated from the plurality of pins of the controller 450 as the predetermined pins to be detected, and the peripheral control unit 430 is controlled to perform the detection. In Step S540, according to the command of the control unit 410, the peripheral control unit 430 respectively detects the signal sources connected to the pins A, B, C, and D at the GPIO port 432 and generates a status signal. In Step S550, the peripheral control unit 430 reports the detected status signal to the control unit 410. With reference to FIG. 4, in this embodiment, the status signal represents that the pins A, B, and D are kept floating while the pin C is grounded. In Step S560, after receiving the foregoing status signal, the control unit 410 determines that the status signal corresponds to the panel C 480 according to information stored in the non-volatile memory 460, and selects the panel parameter corresponding to the panel C 480 from the non-volatile memory 460. That is to say, after receiving the status signal, the control unit 410 determines that the panel type to which the display device is to be applied is the panel C 480 by looking up the information stored in the non-volatile memory 460, and selects the panel parameter corresponding to the panel C 480. In Step S570, the control unit 410 controls the display control unit 420 to generate an output signal according to the panel parameter corresponding to the panel C 480 in the non-volatile memory 460. The panel parameter of the panel C 480 includes setting values corresponding to the resolution, horizontal total pixel count, vertical total pixel count, display interval, and display frequency of the panel C 480. According to the panel parameter of the panel C 480, the display control unit 420 is capable of generating an output signal suitable for the panel C 480 to allow the panel C 480 to correctly display an update status during the process of updating the firmware code. In Step S580, the control unit 410 duplicates the firmware code from the non-volatile memory 460 to the RAM. The control unit 410 then executes the firmware code in the RAM 470 in Step S585, and deletes the firmware code from the non-volatile memory 460 in Step S590. In Step S595, the control unit 410 controls and prompts the external storage device control unit 430 to read the external storage device 490, and to write the firmware update code in the external storage device 490 to the non-volatile memory 460 to complete the firmware update procedure.

It is known from the above descriptions that, in the method for setting a panel parameter for firmware updating according to the embodiment of the disclosure, by storing the panel parameters corresponding to different panel types in the non-volatile memory 460 and welding the predetermined pins to the corresponding to signal sources according to the panel types to be applied during the assembly process, settings for multiple panel parameters corresponding to different panel types can be automatically completed. In other words, in the power-on procedure, by identifying the panel type through the status signal on the pins, the corresponding panel parameter may be selected for automatic setting to preferably operate the panel of the display device. Thus, the display device is allowed to display the update status via the panel during the firmware update procedure to keep a user well informed of the firmware update progress through the displayed content.

Therefore, it is demonstrated with the above embodiment that, in the method for setting a panel parameter of the disclosure, the predetermined pins of the controller are set in advance and the corresponding panel parameter is automatically set according to the status signal presented by the predetermined pins, thereby allowing the panel to correctly perform display and to display the update progress during the firmware update procedure via the image displayed on the display panel.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A parameter setting method, applied to a display device, the display device comprising a controller and a display panel, the method comprising:
storing a plurality of panel parameters to a non-volatile memory, the panel parameters respectively corresponding to a plurality of panels types;
detecting a status signal of a pin of the controller, the status signal corresponding to a type of the display panel;
selecting a panel parameter from the panel parameters according to the status signal; and
generating an output signal according to the selected panel parameter.

2. The method according to claim 1, wherein each of the panel parameters comprises at least one setting value of a panel resolution, a horizontal total pixel count, a vertical total pixel count, a display interval, and a display frequency.

3. The method according to claim 1, wherein the pin is an input/output (IO) pin of a general purpose input/output (GPIO) port.

4. The method according to claim 1, further comprising:
designating the pin from a plurality of pins of the controller during a power-on procedure of the display device.

5. The method according to claim 1, the non-volatile memory further storing a firmware code, the display device further comprising a random access memory (RAM), the method further comprising:
detecting whether an external storage device stores an update data when receiving an update command;
executing the firmware code in non-volatile memory if an update command has not been received or the external storage device does not store the update data; and
performing the following steps if an update command is received and the external storage device stores the update data:
duplicating the firmware code from the non-volatile memory to the RAM;
executing the firmware code in the RAM and deleting the firmware code in the non-volatile memory; and
duplicating the update data in the external storage memory to the non-volatile memory.

6. A controller, applied to a display device, comprising a display panel and a non-volatile memory, the non-volatile memory storing a plurality of panel parameters, the controller comprising:
a pin;
a detecting unit, for detecting a status signal of the pin, the status signal corresponding to a type of the display panel;
a control unit, for selecting a panel parameter from the panel parameters according to the status signal; and
a display control unit, for generating an output signal according to the selected panel parameter.

7. The controller according to claim 6, wherein the panel parameters respectively correspond to different types of panels.

8. The controller according to claim 6, wherein each of the panel parameters comprises at least one setting value of a panel resolution, a horizontal total pixel count, a vertical total pixel count, a display interval, and a display frequency.

9. The controller according to claim 6, wherein the pin is an IO pin of a GPIO port.

10. The controller according to claim 1, wherein the controller designates the pin from a plurality of pins of the controller during a power-on procedure of the display device.

11. The controller according to claim 6, further comprising:
an access unit, for accessing an external storage device storing an update data;
wherein, the control unit stores a firmware code in the non-volatile memory to a RAM of the display device and stores the update data to the non-volatile memory.

12. The controller according to claim 11, wherein the controller executes the firmware code in the RAM.

13. The controller according to claim 11, wherein the control unit deletes the firmware code in the non-volatile memory.
